(19) United States
(12) Patent Application Publication
(10) Pub. No.: US 2008/0191388 A1
(43) Pub. Date: Aug. 14, 2008

(54) Partitioned Mold And Molding Process

(76) Inventors: Bernd Bultermann, Graz-Weinitzen (AT); Laszlo Szolosi, St. Catharines (CA)

Correspondence Address: MAGNA INTERNATIONAL, INC., 337 MAGNA DRIVE, AURORA, ON, L4G-7K1, omitted

(21) Appl. No.: 12/029,559

(22) Filed: Feb. 12, 2008

Related U.S. Application Data
(60) Provisional application No. 60/889,574, filed on Feb. 13, 2007.

(51) Int. Cl. B29C 45/10; B29C 45/22

(52) U.S. Cl. 264/297.1; 425/572

(57) ABSTRACT

A novel partitioned mold and molding method allows for the molding of articles of a larger size on a given molding machine than would otherwise be possible on the molding machine. The mold cavity is partitioned into two or more portions which are separately injected. The partitions can be removed between respective injections of molten material, or can be mold-in-place partitions which remain in the mold as the entire molding operation is performed and which form part of the finished molded article.

This application claims the benefit of U.S. Provisional Application No. 60/889,574, filed Feb. 13, 2007.

### FIELD OF THE INVENTION

The present invention relates to a system and method for molding articles. More specifically, the present invention relates to a system and method for making molded articles using a partitioned mold.

### BACKGROUND OF THE INVENTION

Injection molding of articles requires that the molding machine have sufficient clamp force to maintain the mold cavity closed against the force exerted by the molten material injected into the mold to fill the mold cavity.

As larger articles are molded and/or the pressure at which the molten material is injected into the mold cavity increases, the required clamp force increases. Typically, the clamp force of the molding machine is the primary limitation to the size of the articles which can be molded on the machine.

Depending upon the size of the article to be molded and the material (plastics, metals, thixotropic materials such as magnesium alloys) from which the article is to be molded, the properties of which require different injection pressures, the required clamp force can be many thousands of tons and such machines are expensive to buy and can be difficult and/or dangerous to operate and maintain.

It is desired to have a system and method of molding large articles which requires a lower clamp force than would be required by known systems and methods.

### SUMMARY OF THE INVENTION

It is an object of the present invention to provide a novel partitioned mold and molding process which obviates or mitigates at least one disadvantage of the prior art.

According to a first aspect of the present invention, there is provided a partitioned mold for molding an article, the mold including: a mold cavity including at least one partition to divide the mold cavity into separate cavity portions; and at least one gate allowing the injection of molten material from at least one nozzle into each separate cavity portion, the injection of molten material into each of the separate cavity portions in a sequential manner wherein one injection is completed before the next injection occurs.

According to another aspect of the present invention, there is provided a method of molding an article of a larger size than could otherwise be molded on a molding machine, the method comprising the steps of: (i) dividing the mold cavity with at least one partition into at least two separate mold cavity portions, each mold cavity portion being of a size capable of being molded on the molding machine; (ii) injecting molten material into a first of the at least two separate mold cavity portions to form a first portion of the molded article; (iii) sequentially, in turn, injecting molten material in each remaining mold cavity portion of the at least two mold cavity portions to form the remaining portions of the molded article; and (iv) opening the mold to remove the finished molded article from the mold.

The present invention provides a novel partitioned mold and molding method which allows for the molding of articles of a larger size than would otherwise be possible on a molding machine by partitioning the mold cavity into two or more portions which are separately injected. The partitions can be removed between respective injections of molten material, or can be mold-in-place partitions which remain in the mold as the entire molding operation is performed and which form part of the finished molded article.

### BRIEF DESCRIPTION OF THE DRAWINGS

Preferred embodiments of the present invention will now be described, by way of example only, with reference to the attached Figures, wherein:

FIG. 1 shows a cross section through an injection nozzle and a mold for an article, in accordance with the present invention;

FIG. 2 shows a cross section of the mold of FIG. 1 wherein a first shot of molten material has been injected into a first cavity portion separated from a second cavity portion by a partition;

FIG. 3 shows a cross section of the mold of FIG. 2 wherein the partition has been removed and a gate to the second cavity portion has been opened;

FIG. 4 shows a cross section of the mold of FIG. 3 wherein a second shot of molten material has been injected into the second cavity portion to complete a molded article;

FIG. 5 shows a cross section of the mold of FIG. 4 wherein the mold has been opened and the gate moved to a position to allow ejection of waste material;

FIG. 6 shows a cross section of the mold of FIG. 5 wherein the molded article and the waste material have been ejected;

FIG. 7 shows a perspective view of the top and side of the molded article formed in the first cavity portion;

FIG. 8 shows a top view of the molded article formed in the first cavity portion;

FIG. 9 shows a perspective view of the front, side and top of an embodiment of a mold-in-place partition in accordance with the present invention;

FIG. 10 shows a cross section of the partition of FIG. 9, taken along line 10-10;

FIG. 11 shows a cross section of a mold similar to that of FIG. 3 but wherein the partition of FIG. 9 has been left in the mold cavity when the second shot of molten material has been injected into the second cavity portion to complete a molded article;

FIG. 12 shows a cross section through another mold in accordance with the present invention wherein a gate to a first cavity portion is in fluid communication with the nozzle and a first shot has been injected into the first cavity portion;

FIG. 13 shows a cross section of the mold of FIG. 13 wherein the mold has been moved with respect to the platen to bring the gate to a second cavity portion into fluid communication with the nozzle;

FIG. 14 shows the cross section of FIG. 13 wherein a second shot of molten material has been injected into the second cavity portion;

FIG. 15 shows a cross section view of another partitioned mold in accordance with the present invention;

FIG. 16 shows a cross section of the mold of FIG. 15 wherein a first shot of molten material has been injected into a first cavity portion separated from a second cavity portion by a partition;

FIG. 17 shows a cross section of the mold of FIG. 16 after the partition has been removed and a slide has been moved to open a gate into the second cavity portion;

FIG. 18 shows a cross section of the mold of FIG. 17 where a second shot of molten material is being injected into a second cavity portion;

FIG. 19 shows a cross section of the mold of FIG. 18 where the injection has been completed by returning the slide to a position to close the gate to the second cavity portion;

FIG. 20 shows a cross section of the mold of FIG. 19 in an opened state, prior to removal of the molded article; and

FIG. 21 shows a cross section through another mold in accordance with the present invention wherein two nozzles are employed.

### DETAILED DESCRIPTION OF THE INVENTION

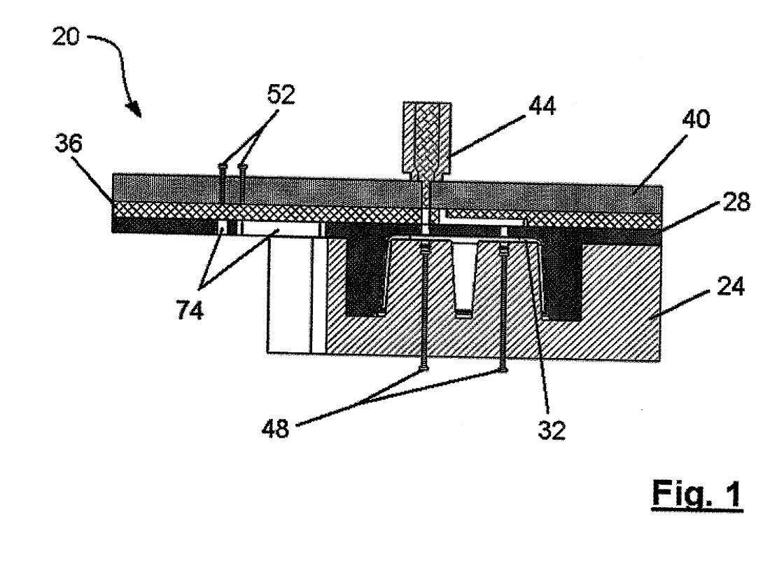

A partitioned mold in accordance with the present invention is indicated generally at 20 in FIG. 1. Mold 20 includes a lower mold portion 24 and an upper mold portion 28 which, between them, define a mold cavity 32.

Upper mold portion 28 abuts a sliding gate 36 which, in turn, abuts a platen 40 and an injection nozzle 44. Lower mold portion 24 includes a pair of part ejector rods 48 which can be actuated through pneumatic, hydraulic or any other suitable means to eject molded parts from mold cavity 32 as described in more detail below. Platen 40 includes a pair of ejector pins 52 which can be actuated through pneumatic, hydraulic or any other suitable means to eject waste material from the sliding gate 36, as described in more detail below. At the start of a mold cycle, ejector rods 48 and ejector pins 52 are in the retracted position shown in FIG. 1.

While this embodiment of the invention shows a sliding gate 36, it is also contemplated that a rotating gate can be employed instead. In such an embodiment, a rotating gate plate can be employed instead of the sliding plate of sliding gate 36 and such a rotating gate plate can offer advantages, including easier sealing of the gates.

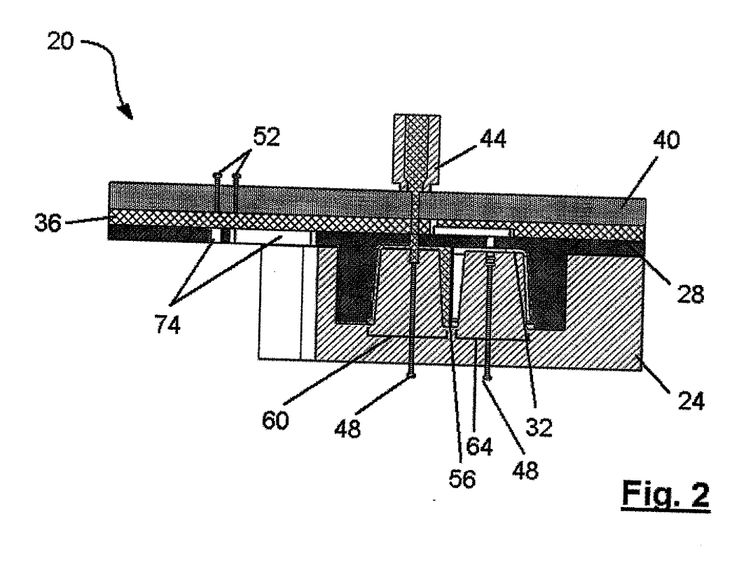

FIG. 2 shows the start of an injection cycle for partitioned mold 20 of FIG. 1. A partition 56 has been inserted into mold cavity 32. In the illustrated embodiment partition 56 is a movable slide which is inserted into mold cavity 32 and/or removed therefrom by a hydraulic actuator, not shown. When in mold cavity 32, partition 56 separates mold cavity 32 into a first cavity portion 60 and a second cavity portion 64.

While the illustrated embodiment shows a sliding gate 36, it will be apparent to those of skill in the art that the present invention is not limited to such gating mechanisms and any suitable method of gating molten material into each of first cavity portion 60 and second cavity portion 64 can be employed. For example, it is contemplated that respective ones of two injector nozzles can be employed to provide molten material to each of first cavity portion 60 and second cavity portion 64 or a single injection nozzle with a hot runner with two gates can be employed.

As illustrated, in the initial position of sliding gate 36, injection nozzle 44 is in fluid communication with the interior of first cavity portion 60 after partition 56 is inserted and mold 20 is closed A shot of molten material is thus injected into first cavity portion 60 from nozzle 44.

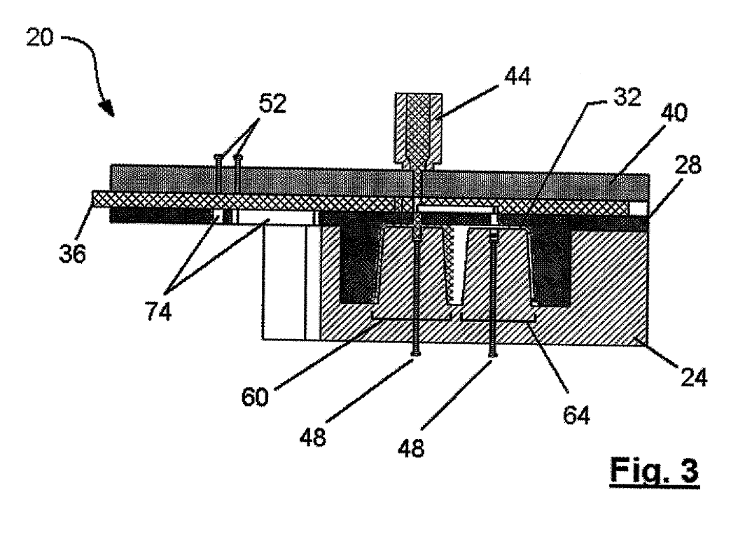

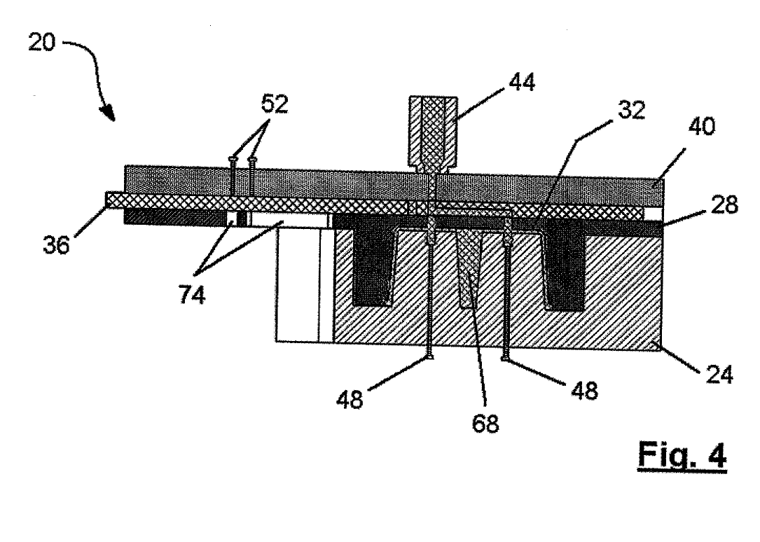

Once the molten shot in first cavity portion 60 solidifies, partition 56 is retracted from mold cavity 32. Sliding gate 36 is then moved to the position illustrated in FIG. 3 so that nozzle 44 is brought into fluid communication with second cavity portion 64. A shot of molten material is thus injected into second cavity portion 64 from nozzle 44. As this molten material solidifies, the molded article 68 is completed as shown in FIG. 4.

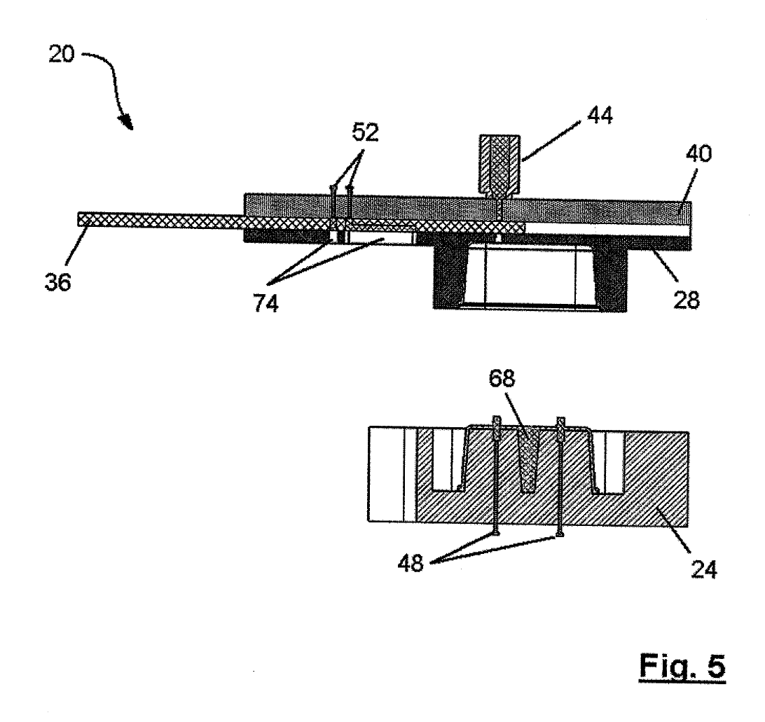

At this point, mold 20 is opened, as shown in FIG. 5, and sliding gate 36 is moved to a position wherein ejector pins 52 align with the gate bores through sliding gate 36.

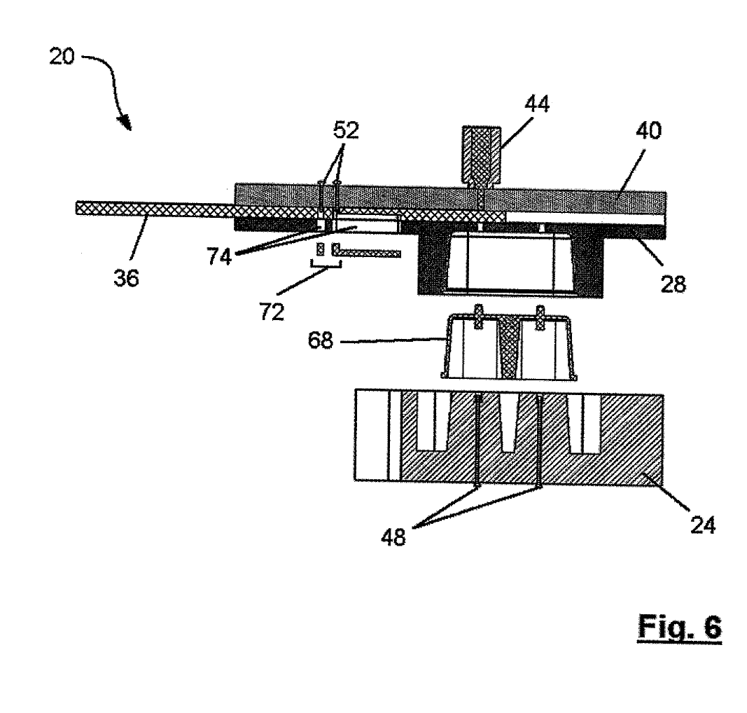

Ejector pins 52 are then stroked through sliding gate 36 to eject the solidified waste material 72 from the gate bores, through passages 74 provided in upper mold portion 28 for that purpose, as shown in FIG. 6. Ejector rods 48 are also stroked to eject finished article 68 from lower mold portion 28, as also shown in FIG. 6.

At this point, mold 20 is returned to the configuration shown in FIG. 2. Namely, ejector pins 52 are retracted and sliding gate 36 is returned to the position shown in FIG. 2. Similarly, ejector rods 48 are returned to their position in FIG. 2 and partition 56 can be reloaded into cavity 32 and mold 24 closed, ready for the injection of a shot of molten material into first cavity portion 60.

To provide a good structural connection between the portion of article 68 molded in first cavity portion 60 and the portion of article 68 molded in second cavity portion 64, it is presently preferred that the side of partition 56 forming part of first cavity portion 60 include mold features which result in structural features being formed on the portion of article 68 molded in first cavity portion 60. When partition 56 is removed and the molten shot of material is injected into second cavity portion 64, the molten material flows around and into these structural features to provide a good structural connection therebetween as the molten material solidifies.

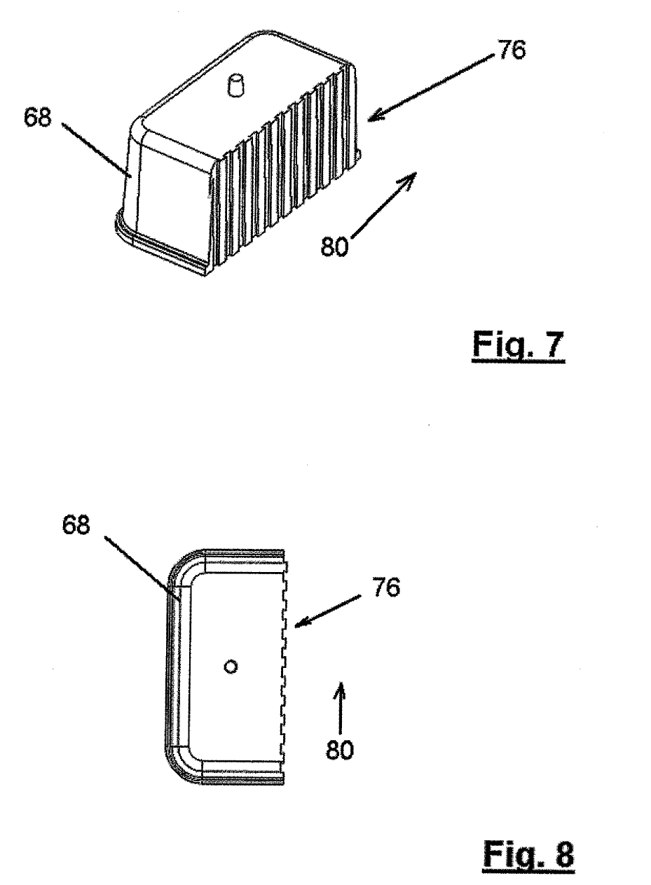

FIGS. 7 and 8 show a set of structural features 76, in the form of a series of dovetail channels, which have been formed in the portion of article 68 molded in first cavity portion 60 and which the molten material injected into second cavity portion 64, once partition 56 is retracted, will fill in to provide the desired structural interconnection between the two portions of article 68. As will be apparent to those of skill in the art, the present invention is not limited to the use of dovetail or any other specific structural features and any suitable structural feature, or set of features, can be employed.

In fact, it is contemplated that the specific structural features employed will be selected depending upon the anticipated loads and stresses expected on finished article 68. For example, the dovetail grooves of FIGS. 7 and 8 may be preferred if it is expected that article 68 will normally be subjected primarily to shear forces in direction 80 such that the expected shear forces extend orthogonally to the length of the dovetail grooves. Other suitable configurations and/or patterns of structural features 76 will be apparent to those of skill in the art.

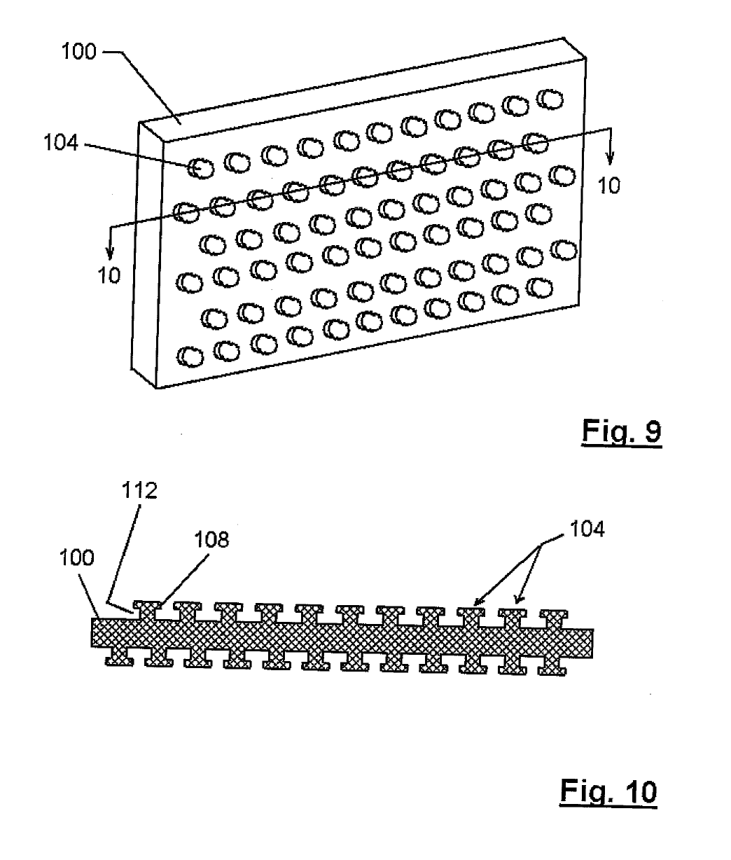

In another embodiment of the present invention, a mold-in-place partition 100, best seen in FIGS. 9 and 10, is employed to separate first cavity portion 60 and second cavity portion 64. Mold-in-place partition 100 is molded in to article 68 and forms part of finished article 68. Partition 100 can be formed from the same material from which finished article 68 is to be formed, or partition 100 can be formed of any suitable material as will occur to those of skill in the art.

If partition 100 is formed from a different material than the material from which the remainder of article 68 is formed, then partition can also be employed to alter the structural characteristics of article 68. For example, if partition 100 is fabricated from a material with higher load carrying capabilities than the material of which the rest of article 68 is molded, partition 100 can be used to structurally strengthen article 68, for example providing additional load carrying capacity at the part of article 68 which is expected to carry the greatest load, etc. It is contemplated that this can be advantageous if the material of partition 100 is more expensive than the material from which the rest of article 68 is to be molded, or if the material of partition 100 cannot be easily molded.

Alternatively, if partition 100 is fabricated from a material with a lower tensile or compressive strength than the material from which the rest of article 68 is molded, then partition 100 can provide a predefined failure point, i.e.—a desired crush zone or fracture line, for article 68.

Partition 100 preferably includes structural features 104 which provide a good structural engagement with the solidified material in first cavity portion 60 and second cavity portion 64 when article 68 is molded. While in the illustrated embodiment structural features 104 are generally mushroom-shaped, with radially larger heads 108 spaced from the surface of partition 100 on shafts 112, it should be apparent to those of skill in the art that the present invention is not limited to any particular shape or configuration of structural features 104 and any suitable shape or configuration of structural feature 104, as will occur to those of skill in the art, can be employed.

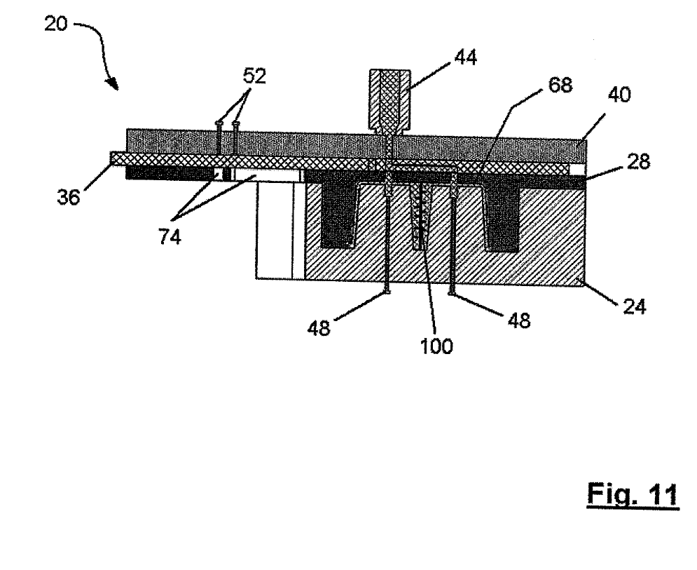

As shown in FIG. 11, wherein each of first cavity portion 60 and second cavity portion 64 has received their respective shots of molten material, partition 100 has been molded into article 68.

While in the discussion above mold cavity 32 has been divided into first cavity portion 60 and second cavity portion 64 by partition 56, or partition 100, the present invention is not limited to only dividing mold cavity 32 into two portions. Specifically, if desired, it is contemplated that two partitions 56 or 100 can be placed in mold cavity 32 to form a first cavity portion, a second cavity portion and a third cavity portion. In such a case, molten material will be injected into one of the first, second and third cavity portions, then molten material will be injected into one of the remaining two of first, second and third cavity portions and then finally, molten material will be injected into the remaining one of the first, second and third cavity portions. In fact, the present invention is not limited to mold cavity 32 being divided into two or even three mold cavity portions and it is contemplated that mold cavity 32 can be divided into four, or even more, cavity portions by three or more partitions 56 or 100 if desired.

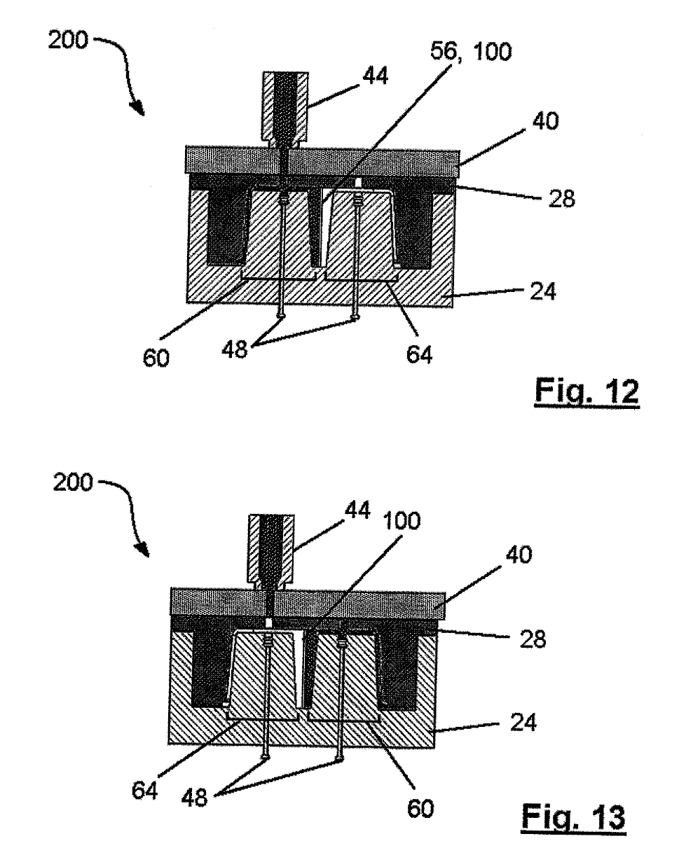

Another mold in accordance with the present invention is indicated generally at 200 in FIGS. 12 through 14 wherein like components to those of FIGS. 1 through 6 are indicated with like reference numerals. In FIG. 12, mold 200 has had either a removable partition 56 or a mold-in-place partition 100 inserted into the mold cavity formed by lower mold portion 24 and upper mold portion 28 to divide the mold cavity into first cavity portion 60 and second cavity portion 64. Nozzle 44 has provided a first shot of molten material to fill first cavity portion 60.

If a removable partition 56 has been placed in the mold cavity, then once first cavity portion 60 has been filled, upper mold portion 28 is separated from lower mold portion 24 and partition 56 is removed and mold 200 is closed again.

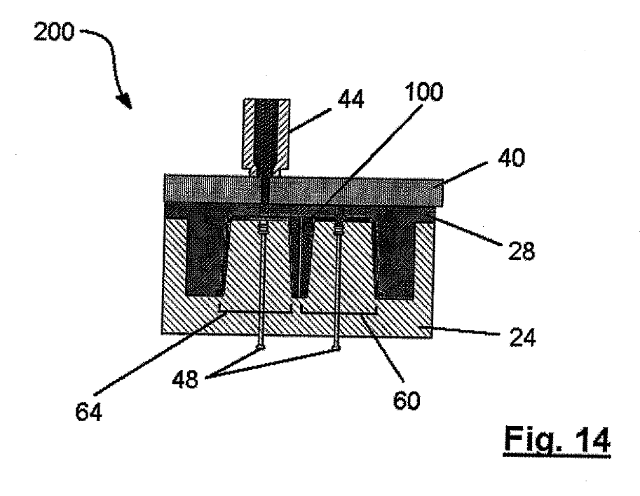

Once partition 56 has been removed and the mold re-closed, or if a mold-in-place partition 100 has been employed (as indicated in FIGS. 13 and 14), the mold is moved with respect to platen 40 such that the gate to second mold portion 64 is brought into fluid communication with nozzle 44, as illustrated in FIG. 13.

The particular mechanism employed to move the mold with respect to platen 40 is not particularly limited and it is presently preferred that upper mold portion 28 and lower mold portion 24 be mounted on a turntable which permits their rotation between the position shown in FIG. 12, wherein the gate to first mold portion 60 is in fluid communication with nozzle 44, and the position shown in FIGS. 13 and 14, wherein the gate to second mold portion 64 is in fluid communication with nozzle 44. However, it is also contemplated that mold 200 can be moved linearly along platen 40, if desired, or in any other suitable manner as will occur to those of skill in the art. If mold 200 includes partitions 56 or 100 to divide the mold cavity into more than first and second portions, then a linear movement of mold 200 with respect to platen 40 can be preferred.

Once the mold has been placed in the position illustrated in FIG. 13, nozzle 44 provides a second shot of molten material to fill second cavity portion 64 as illustrated in FIG. 14. When the second shot has cooled sufficiently, lower mold portion 24 can be separated from upper mold portion 28 and ejector rods 48 can be stroked to eject finished article 68.

As should be apparent to those of skill in the art, for the next cycle of mold 200, once a partition 56 or 100 has been loaded, mold 200 can remain in the position shown in FIGS. 13 and 14 to receive the first shot of molten material from nozzle 44 into second cavity portion 64. Mold 200 will then be moved, with respect to platen 40 to bring the gate to first cavity portion 60 into fluid communication with nozzle 44 and the second shot of molten material from nozzle 44 will fill first cavity portion 60. The cavity portion which receives the first shot of molten material can thus alternate for each molding cycle.

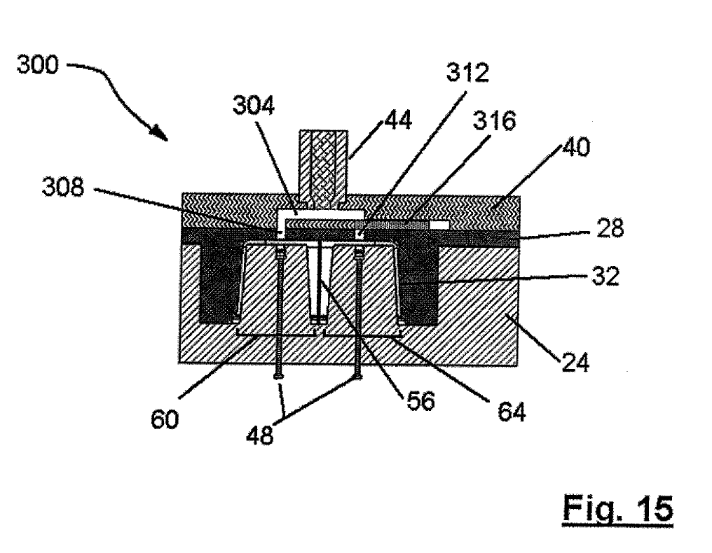

Another partitioned mold 300, in accordance with the present invention, is illustrated in FIG. 15, wherein like components to those of FIGS. 1 through 6 are indicated with like reference numerals. In this embodiment, as before, mold cavity 32 is divided into first cavity portion 60 and second cavity portion 64 by either partition 56 or by a mold-in-place partition 100, not shown.

Nozzle 44 is in fluid communication with a hot runner 304 through platen 40 and hot runner 304 is in fluid communication with a gate 308 to first cavity portion 60. Gate 312, to second cavity portion 64, is brought into, or taken out of, fluid communication with hot runner 304 by a slide 316, shown in FIG. 15 in the position closing gate 312. Slide 316 can be operated hydraulically, or in any other suitable manner as will occur to those of skill in the art.

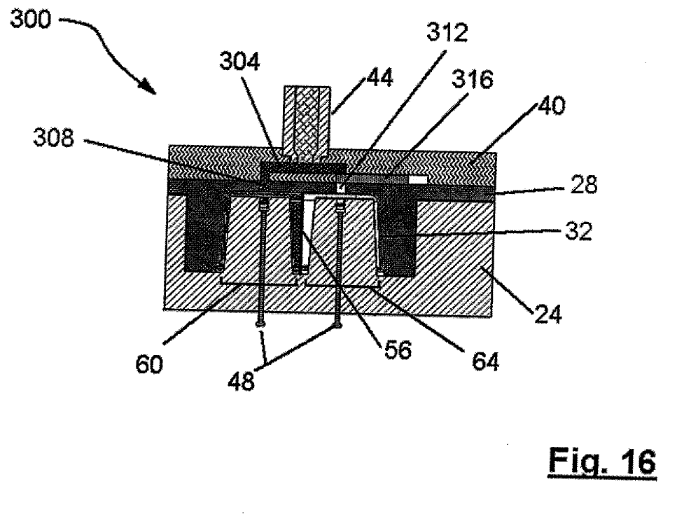

When mold 300 is closed to mold an article, slide 316 is in the closed position and molten material from nozzle 44 is injected into first cavity portion 60, through gate 308 as shown in FIG. 16. Gate 308 is gated by conventional thermal gating.

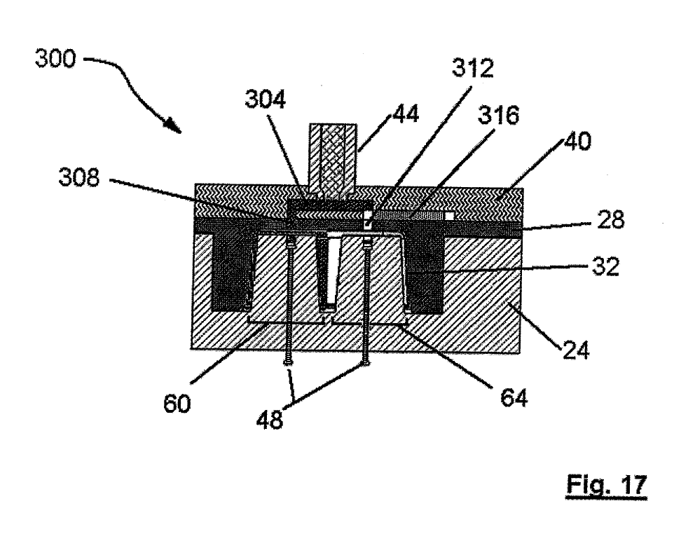

As shown in FIG. 17, once the material in first cavity portion 60 is sufficiently solidified, partition 56 is removed (if a mold-in-place partition 100 is employed, it is left in place). Slide 316 is moved to open position bringing gate 312 into fluid communication with hot runner 304.

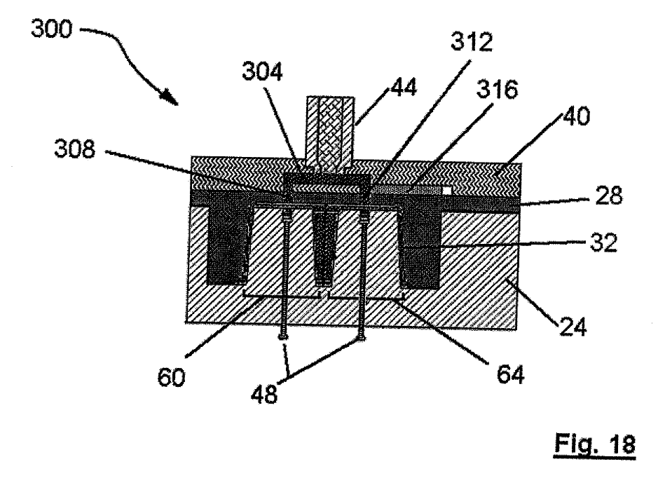

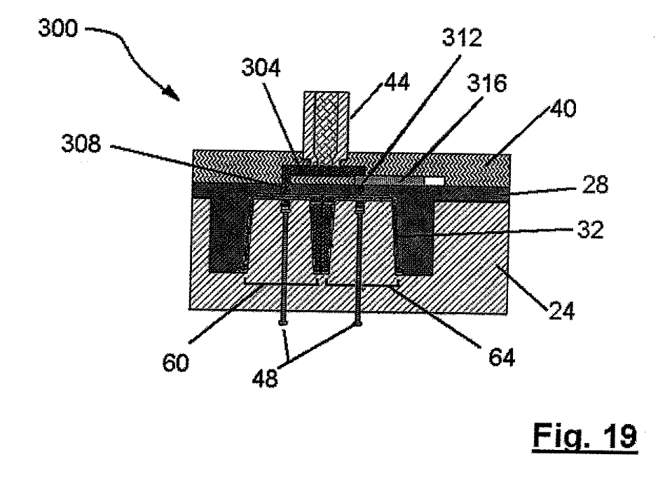

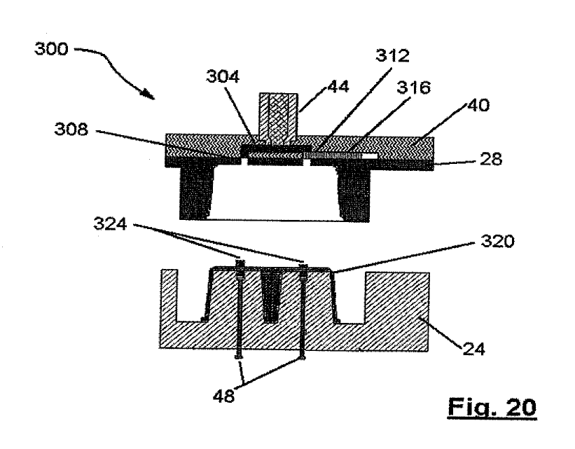

As shown in FIG. 18, molten material is then injected into second mold cavity 64 to complete the article and, as shown in FIG. 19, slide 316 is returned to the closed position as the injection of molten material into second cavity portion 64 completes. As will be apparent to those of skill in the art, the movement of slide 316 to the closed position displaces molten material into second cavity portion 64, assisting in ensuring that second cavity portion 64 is filled.

Once the molten material in second cavity portion 64 is sufficiently solidified, the mold can be opened, as shown in FIG. 20. The molded article 320 includes sprues 324 of material which is cleared from gates 308 and 312 as the mold is opened. Molded article 320 can then be removed from mold cavity 32 by stroking ejector rods 48 and the mold cavity 32 can be closed to perform another mold cycle.

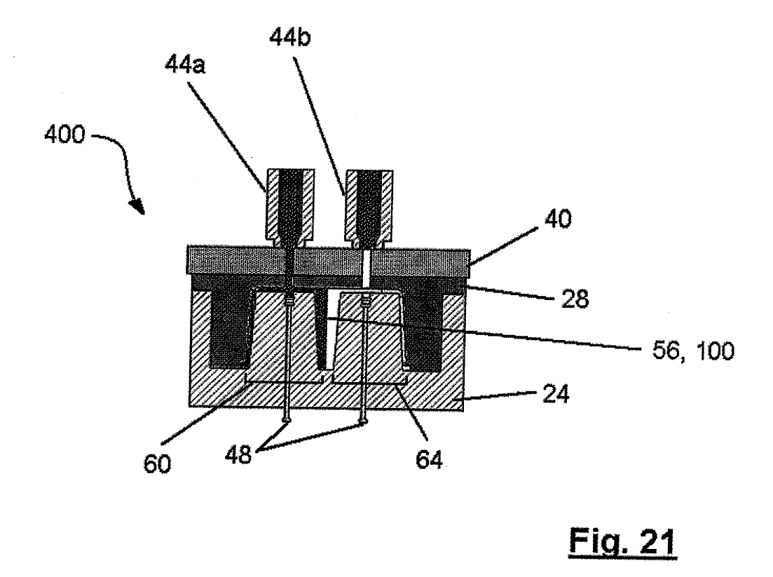

Another partitioned mold 400 in accordance with the present invention is shown in FIG. 21, wherein like components to those of FIGS. 1 through 6 are indicated with like reference numerals. As illustrated, platen 40 for mold old 400 includes a nozzle 44a and 44b for each respective mold cavity portion 60 and 64. In this embodiment, nozzle 44a will provide a molten shot to fill mold cavity portion 60, as shown in the Figure, after which nozzle 44b will provide a molten shot to fill mold cavity portion 64. Each of nozzles 44a and 44b can be gated in any suitable manner, as will occur to those of skill in the art, such as thermal gating, valve gating, etc.

As will be apparent to those of skill in the art, the present invention is not limited to the use of two nozzles 44 and more nozzles can be employed if mold 400 includes more than two mold cavity portions.

Further, it is also contemplated that two or more nozzles 44 can be employed, with one or more of those nozzles 44 being used in conjunction with any of the above described embodiments, such as the sliding or rotating gate, to fill two or mold cavity portions. Thus, for example, two nozzles 44 could be used to fill four mold cavity portions, etc.

The present invention provides a novel partitioned mold and molding method which allows for the molding of articles of a larger size than would otherwise be possible on a given molding machine by partitioning the mold cavity into two or more portions which are separately injected. The partitions can be removed between respective injections of molten material, or can be mold-in-place partitions which remain in the mold as the entire molding operation is performed and which form part of the finished molded article. The mold need not be opened between injections of molten material into cavity portions and thus good cycle times can be achieved with the mold and molding method.

The above-described embodiments of the invention are intended to be examples of the present invention and alterations and modifications may be effected thereto, by those of skill in the art, without departing from the scope of the invention which is defined solely by the claims appended hereto.

We claim:

1. A partitioned mold for molding an article, the mold including:
a mold cavity including at least one partition to divide the mold cavity into separate cavity portions; and
at least one gate allowing the injection of molten material from at least one nozzle into each separate cavity portion, the injection of molten material into each of the separate cavity portions in a sequential manner wherein one injection is completed before the next injection occurs.

2. The partitioned mold of claim 1 wherein the partition is removed from the mold cavity after the injection of molten material into one of the separate cavity portions formed by the partition.

3. The partitioned mold of claim 2 wherein the partition includes mold features to form structural features in the material injected the one of the separate cavity portions formed by the partition, the structural features enhancing the interconnection of the material injected into the one of the one of the separate cavity portions to material injected into the other of the separate cavity portions after the partition is removed.

4. The partitioned mold of claim 2 wherein the partition is in the form of a slide moveable into and out of the mold cavity.

5. The partitioned mold of claim 1 wherein the gate is in the form of a plate moveable between at least first and second positions, in the first position the nozzle being in fluid communication with one of the separate cavity portions and, in the second position, the nozzle being in fluid communication with another of the separate cavity portions.

6. The partitioned mold of claim 5 wherein the plate moves in a reciprocating linear manner.

7. The partitioned mold of claim 5 wherein the plate moves in a rotary manner.

8. The partitioned mold of claim 1 wherein the partition is a mold-in-place partition placed into the mold cavity prior to closing the mold.

9. The partitioned mold of claim 8 wherein the partition includes structural features to enhance the interconnection of the portions of the molded article formed in each separate cavity portion.

10. A method of molding an article of a larger size than could otherwise be molded on a molding machine, the method comprising the steps of:
(i) dividing the mold cavity with at least one partition into at least two separate mold cavity portions, each mold cavity portion being of a size capable of being molded on the molding machine;
(ii) injected molten material into a first of the at least two separate mold cavity portions to form a first portion of the molded article;
(iii) sequentially, in turn, injecting molten material in each remaining mold cavity portion of the at least two mold cavity portions to form the remaining portions of the molded article; and
(iv) opening the mold to remove the finished molded article from the mold.

11. The method of claim 10 wherein the partition between adjacent mold cavity portions is removed after molten material injected into one of the adjacent cavity portions has solidified.
